(19) United States
(12) Patent Application Publication
(10) Pub. No.: US 2025/0293776 A1
(43) Pub. Date: Sep. 18, 2025

(54) DETECTION AND/OR COMMUNICATION SYSTEM FOR A MOTOR VEHICLE COMPRISING A MODULE FOR RECEIVING A LIGHT BEAM

(71) Applicant: VALEO VISION, Bobigny (FR)

(72) Inventors: Pierre RENAUD, Bobigny (FR); Yolande SIKALI-MAMDEM, Bobigny (FR)

(73) Assignee: VALEO VISION, Bobigny (FR)

(21) Appl. No.: 18/863,135

(22) PCT Filed: Apr. 26, 2023
(86) PCT No.: PCT/EP2023/061043

§ 371 Date: Nov. 5, 2024

(30) Foreign Application Priority Data
May 5, 2022 (FR) FR2204257

(51) Int. Cl. H04B 10/116; G01S 17/10; H04B 10/69

(52) U.S. Cl. CPC H04B 10/116; G01S 17/10; H04B 10/6972

(57) ABSTRACT

The invention relates to a system of an automotive vehicle, including a reception module able to receive a light beam. The reception module includes an elementary acquisition module including a photodetector able to convert a light signal it receives into an electrical signal. The reception module includes an optical unit arranged in front of the elementary acquisition module, the optical unit including a lens made of an absorbent material to form a first optical bandpass filter able to transmit a first wavelength range and an optical element arranged to form a second optical interference filter able to transmit a second wavelength range at least partially included in the first range and substantially narrower than the first range.

### TECHNICAL FIELD

The invention relates to the field of automotive lighting and data transmission functions using the light emitted by an automotive lighting system. More precisely, the invention relates to a system of an automotive vehicle for receiving data transmitted by a light beam.

### BACKGROUND OF THE INVENTION

In the automotive field, it is known to use a light beam emitted by a luminous module both to perform a given photometric function and to transmit data.

Conventionally, the light source used to emit this light beam is controlled by a pulse-width-modulated (PWM) electrical signal. The light source is thus periodically activated and deactivated by this PWM signal, so that the emitted light beam is composed of successive light pulses with a frequency high enough that the human eye no longer distinguishes them. The intensity of the emitted light beam depends on the duty cycle of this PWM signal, enabling said intensity to be controlled by adjusting this duty cycle. This PWM signal can then be modulated using a data sequence so that this data sequence is carried by the light beam. This enables the light beam to retain its original function, namely to perform a photometric function, while carrying the data sequence. This type of technology is for example known as visible light communication (VLC), or also light fidelity (LiFi).

Thus, beyond performing one or more photometric functions, such as a daytime running lamp or low-beam lighting, various functions can be implemented by this type of luminous module. For example, the luminous module can thus be integrated into an emission module able to perform functions involving communication of a data sequence with another vehicle or with a piece of infrastructure which is equipped with a reception module able to demodulate the light beam received in order to extract the data sequence therefrom. In another example, the headlight including the emission module may be equipped with a reception module in order to receive the emitted light beam, after reflection on an object in the vicinity of the vehicle. It is then possible, by demodulation and extraction of the transmitted data sequence, to determine the time-of-flight of the emitted light beam and thus evaluate the distance separating the vehicle from the object.

However, this type of system based on the use of an emission module able to perform both a photometric light function and data transmission has a drawback. The reception module intended to receive the light beam carrying the data, whether it is arranged in the same vehicle or in another vehicle, must include at least one photodetector for converting this light beam into an electrical signal in order to demodulate this signal and extract a data sequence therefrom.

Under certain conditions, the signal-to-noise ratio of this photodetector may be significantly degraded. This is notably the case in bright sunlight. Indeed, under such conditions, the light from the sun, in the visible spectrum in which the light source of the emission module operates, may be substantially greater than the light from the received light beam, thereby saturating the photodetector. In this state, the photodetector enters a non-linear operating state and is unable to adequately convert the light beam into an electrical signal that can be demodulated without loss of information.

To avoid this saturation of the photodetector, the received light beam could be filtered to a very narrow wavelength band, for example between 420 nm and 470 nm, so as to limit the impact of the sunlight. However, the breadth of the solar irradiance spectrum makes it particularly complex to implement a bandpass filter able to filter the light beam over a narrow band. For example, it would be necessary to superimpose more than fifty thin layers to form an interference filter able to adequately reflect the entire solar irradiance spectrum outside this narrow band. Moreover, beyond the manufacturing complexity, the cost of such a filter to obtain a zero or sufficiently low gain outside the narrow band and to obtain a steep slope of the gain at the limits of this narrow band becomes prohibitive.

### SUMMARY OF THE INVENTION

There is therefore a need for a system able to transmit a data sequence, from an emission module incorporating a luminous module participating in the performance of a photometric function to an acquisition module, in which the signal-to-noise ratio is optimal in all weather conditions, including bright sunlight, and in which the implementation complexity and cost are reasonable.

The present invention falls within this context, and aims to meet this need.

For these purposes, the invention relates to a system of an automotive vehicle, including a reception module able to receive a light beam, the reception module including an elementary acquisition module comprising a photodetector able to convert a light signal it receives into an electrical signal, characterized in that the reception module includes an optical unit arranged in front of the elementary acquisition module, the optical unit including a lens made of an absorbent material to form a first optical bandpass filter able to transmit a first wavelength range and an optical element arranged to form a second optical interference filter able to transmit a second wavelength range at least partially included in the first range and substantially narrower than the first range.

The invention therefore proposes filtering the received light beam in two stages. A first filter roughly narrows this light beam by eliminating a substantial part of the spectrum of this beam, but without the passband of this filter being particularly narrow. This type of filter can easily be made using a lens made of an absorbent material, for example by being body-tinted. A second filter, which is an interference or dichroic filter, then refines the received light beam by selecting a narrow band in the passband of the first filter. Given that most of the spectrum has been eliminated by the first filter, the number of layers in the second filter can be greatly reduced without affecting the performance of this second filter. Consequently, the manufacturing complexity and the cost of this second filter can be reduced. Furthermore, in bright sunlight conditions, when sunlight is added to the light emitted by an emission module, these filters greatly reduce the impact of the sunlight and thus prevent saturation of the photodetector.

It should be noted that the first filter may equally well be arranged upstream of the second filter or vice versa, without departing from the scope of the present invention. Other optical elements forming other interference filters further narrowing the band of the received light beam may also be added. The second range may also be partially or totally within the first range.

Preferably, the optical unit has a focal plane passing through the photodetector of the elementary acquisition module.

In the present invention, the absorbent material of said lens can be selected so that the first optical filter has a transmission coefficient of at least 80% in the first range, or passband, and a transmission coefficient of less than 80% outside the first range. The lens may be made of a single tinted or colored material, such as a glass or a thermoplastic material, to form said first filter, or said lens may be made of a plurality of materials, for example arranged in layers, at least one of which forms said first filter.

Advantageously, the absorbent material of the lens is selected such that the first range is centered on a wavelength of the visible spectrum, i.e. a wavelength between 380 nm and 780 nm. For example, the first optical filter may have a transmission peak, i.e. a peak at which the transmission coefficient is greater than 95%, in the violet or in the blue, notably between 380 nm and 500 nm, in particular at substantially 390 nm or substantially 450 nm. Where appropriate, the first range, i.e. the wavelength range for which the transmission coefficient of the first filter is greater than or equal to 80%, extends partially or completely in the visible spectrum, and may for example be the range 420 nm to 490 nm, the transmission coefficient of the first filter being less than 80% outside this range and notably less than 40% in the green, yellow, red and infrared.

For example, the absorbent material of the lens may be a glass composition as described in patent EP0481165.

In the present invention, the optical element may be arranged so that the second optical filter has a transmission coefficient of at least 80% in the second range, or passband, and a transmission coefficient of less than 80% in the first range outside the second range. The optical element may be arranged so that the second optical filter has a transmission coefficient that may equally well be less than and/or greater than 80% outside the first range. The second optical filter may notably have other passbands outside the first range, without departing from the scope of the present invention. This second, interference filter improves the signal-to-noise ratio of the system by reflecting what has not been absorbed or what should not be absorbed by the first filter.

Advantageously, the optical element is arranged such that the width of the second range is less than 30 nm. For example, the second range may be centered on a wavelength within the first range, for example between 445 nm and 450 nm.

Where the light beam is emitted from a solid-state light source, such as a light emitting diode, the white light used to obtain the light beam is usually obtained from a blue light generator, and a photoluminescent material, or phosphor, absorbing part of this blue light to emit yellow light in response, the rest of the blue light and this yellow light forming white light by additive synthesis. However, this absorption-reemission means that a yellow photon is necessarily emitted more slowly than a blue photon. Therefore, in the context of detecting an obstacle by analyzing a time-of-flight of a light beam, the evaluation resolution of the time-of-flight will necessarily be higher if the evaluation is made using only blue light rather than another wavelength range, or even using the entire visible spectrum. The fact that the second range is centered on a wavelength between 445 nm and 450 nm thus reduces the uncertainty of detecting the distance from an obstacle to the vehicle. Symmetrically, this second range increases the data communication rate between an emission module and the reception module.

In an example embodiment of the invention, the optical element includes a stack of thin layers each alternately having a high refractive index or a low refractive index. The low refractive index will be significantly lower than the high refractive index. Such a configuration is also called a Bragg mirror. The thickness of each layer may for example be determined as a function of the central wavelength of the second range and of the high and/or low refractive indices. It will be noted that the thickness of each layer will be substantially less than the central wavelength of the second range.

For example, one of the following materials may be used for the thin layers having a high refractive index: niobium pentoxide (Nb2O5), titanium dioxide (TiO2), tantalum pentoxide (Ta2O5), zirconium dioxide (ZrO2) or hafnium dioxide (HfO2). Silicon dioxide (SiO2) may for example be used for the thin layers having a low refractive index.

The number of layers in the optical element will advantageously be less than 20 layers. In other words, the design of the optical element is simpler and less costly, as a result of the presence of the first filter.

In one embodiment of the invention, the lens is a plano-convex lens and the optical element is a coating formed on the flat face of the lens. Where appropriate, said flat face of the lens may be the face of the lens oriented toward the elementary acquisition module.

In an alternative or cumulative embodiment, the optical element is a flat plate interposed between the lens and the elementary acquisition module.

Advantageously, the optical unit includes a plurality of lenses including said lens forming the first optical filter and at least one further lens made of a transparent material.

In one embodiment of the invention, the reception module includes a plurality of elementary acquisition modules, each comprising a photodetector able to convert a light signal it receives into an electrical signal. Where appropriate, the optical unit may have a focal plane passing through each of the photodetectors.

For example, the set of photodetectors may form a sensor, for example a single electronic component.

Advantageously, the photodetector of the or each elementary acquisition module is an avalanche photodiode. This type of photodetector is also known as a single-photon avalanche diode (SPAD). The set of avalanche photodiodes can thus form a silicon photomultiplier (SiPM). This type of photodetector can detect the incidence of a single photon with a high gain, for example of the order of 106, and thus compensate for the degradations of the signal-to-noise ratio due to external conditions or to the absorptions by the filters.

Advantageously, the reception module includes a demodulation unit connected to the or to each photodetector and arranged to extract a data sequence from an electrical signal converted by this photodetector.

In one embodiment of the invention, the system includes an emission module including a luminous module able to emit a light beam, the spectrum of which has at least one portion in the second wavelength range, and a modulation unit that is able to receive a data sequence and that is arranged to modulate said emitted light beam using the received data sequence.

For example, the luminous module may be arranged so that the spectrum of the emitted light beam has a first peak in the visible spectrum, for example in a range from 440 nm to 500 nm, notably at 450 nm.

In one embodiment of the invention, the luminous module includes a light source able to emit light rays, of which at least one or at least some wavelengths are situated in the second wavelength range, and an optical unit arranged to project the light rays emitted by the light source to form said light beam. The light source may be a laser source, a light emitting diode, a vertical-cavity surface-emitting laser (VCSEL) or a superluminescent diode (SLED). Where appropriate, the modulation unit may be arranged to control the light source, and notably an electrical power supply to this light source, in order to modulate the light beam.

Advantageously, the modulation unit is arranged to generate a pulse-width-modulated control signal, to modulate said control signal using the received data sequence, and to control the emission of said light beam by the luminous module using the modulated control signal. For example, the modulation unit may be arranged to convert said received data sequence into a modulating signal and to modulate, for example in amplitude, frequency or phase, the control signal with this modulating signal.

Advantageously, the system includes a computing unit arranged to detect, in a data sequence extracted by the demodulation unit from an electrical signal converted by the photodetector from a light beam received by the reception module, the presence of a data sequence modulating the light beam emitted by the emission module and to determine a time-of-flight separating the emission of said emitted light beam from the reception of said received light beam.

Advantageously, the emission module is arranged so that the light beam participates, totally or partially, in the performance of a predetermined statutory photometric function. It may, for example, be a daytime running lamp (DRL), which has the advantage of being emitted over a wide field at a low intensity.

Advantageously, the reception module, and where applicable the emission module, is arranged in a front headlight of the automotive vehicle.

The invention also relates to a reception module for a system of an automotive vehicle according to the invention.

The invention also relates to a front headlight of an automotive vehicle including a reception module, and optionally an emission module, according to the invention.

### BRIEF DESCRIPTION OF DRAWINGS

The present invention is now described using examples that are only illustrative and in no way limit the scope of the invention, and with reference to the appended drawings, in which drawings the various figures show:

FIG. 1 is a schematic partial view of a system of an automotive vehicle according to one example embodiment of the invention;

FIG. 2 schematically and partially shows an example embodiment of a reception module of the system in FIG. 1; and

FIG. 3 schematically and partially shows a transmission spectrum of the optical unit of the reception module in FIG. 2.

### DETAILED DESCRIPTION OF THE INVENTION

Throughout the following description, elements that are identical in terms of structure or function and that appear in various figures have been designated by the same reference signs, unless otherwise specified.

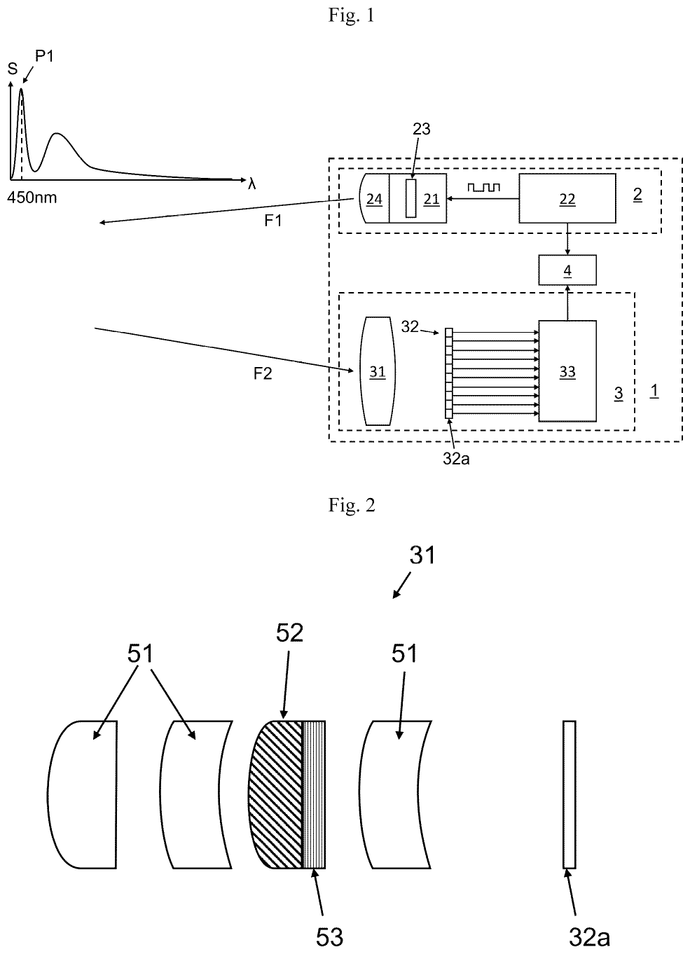

FIG. 1 shows a system 1 of an automotive vehicle according to an example embodiment of the invention.

The system 1 includes an emission module 2 arranged to emit a light beam F1 and a reception module 3 intended to receive a light beam F2.

In the example described, the emission module 2 and the reception module 3 are arranged in one and the same front headlight of the automotive vehicle. The modules 2 and 3 may be arranged at different locations in the automotive vehicle, without departing from the scope of the present invention.

The emission module 2 includes a luminous module 21 and a modulation unit 22.

The luminous module 2 is arranged so that the light beam F1, which it emits, has an electromagnetic spectrum S, at least a portion of which is situated in the visible spectrum. As shown in FIG. 1, the spectrum S has a first intensity peak P1, or line, in the blue, for example at 450 nm. It will be noted that the spectrum S may have other intensity peaks, and notably intensity peaks in the infrared.

In order to emit this light beam F1, the luminous module 21 includes a light source 23 able to emit light rays and an optical unit 24 arranged to project these light rays to form the light beam F1. In the invention, the optical unit 24 may equally well include one or more reflectors, one or more lenses, one or more diaphragms, or one or more collimators, or even a combination of several of these optical elements.

The light source 23 for example includes a solid-state generator (not shown), for example a gallium nitride or GaN, able to emit, by electroluminescence and in response to an electric current passing through said generator, blue light rays with an emission peak at 450 nm. The light source also includes a photoluminescent element, in the form of a resin including cerium-doped yttrium aluminum garnet (CE:YAG), able to absorb blue light and, by photoluminescence and in response to excitation by that light, to emit yellow light rays, with a peak at 550 nm.

The photoluminescent element is arranged on the generator in such a way that a part of the blue light rays excites this element so that it emits, by photoluminescence, rays of yellow light. The other part of the blue light rays passes through this element. Thus, the light source 23 simultaneously emits, when it is electrically powered, rays of blue and yellow light, the light thus formed appearing white to the human eye.

Insofar as the light beam F1 is composed, partially or totally, of white light, it is possible to use this light beam F1 to participate, partially or totally, in the performance of a predetermined photometric function, notably a statutory function. In this case, the optical unit 24 is arranged to shape this light beam F1 so that the photometric distribution thereof satisfies the requirements of said function. For example, the light beam F1 may participate in the performance of a daytime running lamp (DRL) function.

In addition to this photometric function, the light beam F1 enables the system 1 to perform functions of detecting and evaluating the position of an obstacle on the road and/or of communicating with another vehicle or with a piece of road infrastructure.

The modulation unit 22 is able to receive a data sequence, for example a predetermined sequence where it is used to detect and evaluate the position of an obstacle, the sequence being in this case stored in a memory of the system 1 (not shown) or, as a variant, generated by a computer of the system 1 (not shown) to communicate with a system identical to the system in FIG. 1 provided in another vehicle or in a piece of road infrastructure.

The modulation unit 22 is arranged to modulate the light beam F1 emitted by the luminous module 21, using this data sequence, for example by controlling the electrical power supply to the light source 23.

For these purposes, the modulation unit 22 includes a generator of a pulse-width-modulated control signal. This control signal is used to control a switched-mode power supply (not shown) of the light source 23. Conventionally, the duty cycle of this control signal, set by the modulation unit 22, is therefore used to control the average electric power supplied to the light source 23, and therefore to control the luminous intensity of the light beam F1, in order to satisfy the requirements of the photometric function it performs.

In the example described, the modulation unit 22 is arranged to convert the data sequence into a modulating signal and to modulate the initial control signal using this modulating signal. It will be noted that several types of modulation may be employed equally well in the context of the present invention, and notably on-off-keying (OOK) modulation, pulse code modulation (PCM), pulse amplitude modulation (PAM), pulse width modulation (PWM), or pulse position modulation (PPM).

The light beam F1 thus emitted is composed of a train of successive light pulses with a sufficiently high frequency, for example greater than 30 MHz, notably between 70 MHz and 100 MHz, so that the human eye can no longer distinguish them. Furthermore, the amplitude, width and/or position of each pulse with respect to the period allows the light beam F1 to carry the data sequence to the reception module 3.

The reception module 3 includes an optical unit 31, downstream of which are provided a plurality of elementary acquisition modules 32. The reception module 3 further includes a demodulation unit 33.

Each of the elementary acquisition modules 32 includes a photodetector 32a. The light beam F2 received by the reception module 3 is thus concentrated by the optical unit 31 on one or more of the photodetectors 32a.

The light beam F2 may equally well be the light beam F1 emitted by the emission module 2 and reflected by an obstacle or an object situated in the environment of the vehicle toward the reception module 3, or a light beam emitted by an emission module of a system of another vehicle or a piece of road infrastructure equipped with an emission module similar to the module 2.

The photodetectors 32a are identical and are each formed by an avalanche photodiode of a silicon photomultiplier. These photodiodes are distributed in an array. It will be noted that the dimensions of the photodetectors 32a are in the micrometer range. The assembly thus forms a sensor having spatial resolution of reception of the order of 0.1°, and particularly good detection capabilities, even in degraded acquisition conditions, due to the use of avalanche photodiodes.

Each of the photodetectors converts the portion of the light beam F2 that it receives into an electrical signal that it transmits to the demodulation unit 33, which can then extract a data sequence therefrom.

Where the system 1 implements a communication function, this data sequence can then be transmitted to a computer of the vehicle in order to be interpreted, decoded and/or transmitted to equipment or to a user of the vehicle.

Where the system 1 implements a function of detecting and evaluating the position of an object or of an obstacle, this data sequence can be transmitted to a computing unit 4 of the system 1. This computing unit 4 can thus detect therein the presence of a predetermined data sequence with which the modulation unit 22 has modulated the light beam F1 emitted by the luminous module 21. In this case, the computing unit can determine a time-of-flight between the emission of the light beam F1 and the reception of the light beam F2.

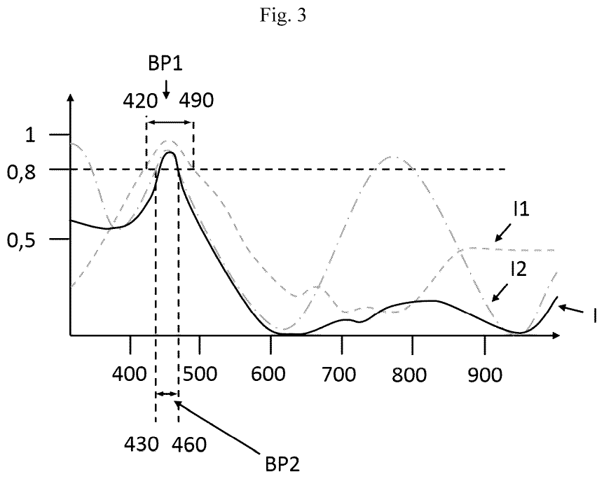

An embodiment of the optical unit 31 is described below with reference to FIG. 2 and FIG. 3.

As shown in FIG. 2, the optical unit 31 includes a plurality of lenses including three lenses 51 made of a transparent or translucent material and a lens 52 made of an absorbent material to form a first optical bandpass filter I1 able to transmit a first wavelength range BP1.

It will be noted that the number of lenses, the profile of the lenses and the respective positions of the lenses illustrated in FIG. 2 constitute a non-limiting example of the invention and that this number, these profiles and these positions can be varied without departing from the scope of the present invention.

In the example described, this set of lenses 51 and 52 has a focal plane passing through the photodetectors 32a of the elementary acquisition modules 32.

The absorbent material of the lens 52 is a tinted glass selected so that the first optical filter I1 has a transmission coefficient of at least 80% in the first wavelength range BP1, and a transmission coefficient of less than 80% outside this first range BP1.

FIG. 3 shows the transmission spectrum of this first optical filter I1 formed by the lens 52 (shown as a dotted line). It can thus be seen that the passband BP1 of the first filter I1, for which the transmission coefficient is greater than or equal to 80%, is a range from 420 nm to 490 nm with a transmission peak at 450 nm. Outside this range, the transmission coefficient is less than 80%, or even less than 50%.

The optical unit 31 also includes an optical element 53 arranged to form a second optical filter I2 able to transmit a second wavelength range BP2 at least partially included in the first range BP1 and substantially narrower than the first range BP1.

In the example shown, the optical element 53 is an interference filter including a stack of thin layers each alternately having a high refractive index or a low refractive index. The high-refractive-index layers are made of titanium dioxide (TiO2) and the low-refractive-index thin layers are made of silicon dioxide (SiO2).

The lens 52 is a plano-convex lens and the optical element 53 is a coating formed on the flat face of this lens oriented toward the photodetectors 32a.

The number of layers and the thickness of the layers have been determined so that the second optical filter I2 has a transmission coefficient of at least 80% in the second range BP2.

FIG. 3 also shows the transmission spectrum of this second optical filter I2 formed by the optical element 53 (shown as a dot-dash line). It can thus be seen that the passband BP2 of the second filter I2, for which the transmission coefficient is greater than or equal to 80%, is a range from 430 nm to 460 nm with a transmission peak at 445 nm. It will be noted that the second optical filter I2 has other passbands outside the first range BP1, without this impacting the performance of the system, as will be described below. In the non-limiting example in FIG. 3, the optical element 53 is formed of 11 superimposed layers.

The set of filters I1 and I2 thus forms a filter I, the transmission spectrum of which has been superimposed on the other transmission spectrums of the filters I1 and I2 in FIG. 3. It can thus be seen that the spectrum of the filter I thus has only one wavelength range, specifically the range BP2, for which the transmission coefficient is greater than 80%.

When the sunlight conditions in the vicinity of the vehicle are particularly bright, the sunlight is thus added to the light beam F2 received by the reception module 3. The light from the sun, in the visible spectrum, is significantly brighter than the light from a photometric function such as a daytime running lamp. Consequently, the light beam F2 received by the reception module 3 is composed firstly of the light beam F1 emitted by the emission module 2, or by another similar emission module, and sunlight. The intensity levels of this F2 beam far exceed those of the F1 beam for the wavelength ranges in the visible range.

However, the combination of the filters I1 and I2 minimizes the influence of the sun on the beam F2, by eliminating all the wavelengths of the beam F2 except those in the second range BP2. This prevents saturation of the photodetectors 32a receiving this beam F2, without the filter I being particularly complex or expensive.

It will also be noted that the filter I makes it possible to keep only the blue component of the beam F2, i.e. the component corresponding to the light rays emitted first by the light source 23, the yellow light rays being emitted with a longer response time due to the delay introduced by photoluminescence. Consequently, carrying out detection solely on the basis of the blue light received by the reception module 3 improves the evaluation resolution of the time-of-flight of the light beam F2 and/or the data transmission rate between an emission module and the reception module 3.

The above description clearly explains how the invention achieves the stated objectives, namely to provide an automotive vehicle system able to perform communication or detection functions using visible light, in which the signal-to-noise ratio is optimum under all weather conditions, including bright sunlight, and in which the implementation complexity and cost are reasonable. These objectives are achieved notably by means of a reception module equipped with two filters, including a first filter made using a lens made of an absorbent material and used to eliminate a substantial part of the spectrum of this beam, and a second interference filter which selects a narrow band in the passband of the first filter.

In any event, the invention is not limited to the embodiments specifically described in this document, and particularly extends to all equivalent means and to any technically operative combination of these means. In particular, other types of light source than the one described, such as a laser diode, a VCSEL or a SLED, may be used. Photometric functions other than the one described may also be performed, notably low-beam lighting functions or position-light signaling functions. Other configurations of the optical element forming the second optical filter, such as a flat plate, are also possible. Other materials may also be used to make the lens or the optical element to obtain the same wavelength ranges or other wavelength ranges, or else to enable the first filter to be arranged upstream of the second filter.

What is claimed is:

1. A system of an automotive vehicle, comprising a reception module able to receive a light beam, wherein the reception module includes an elementary acquisition module including a photodetector able to convert a light signal it receives into an electrical signal, wherein the reception module includes an optical unit arranged in front of the elementary acquisition module, the optical unit including a lens made of an absorbent material to form a first optical bandpass filter able to transmit a first wavelength range and an optical element arranged to form a second optical interference filter able to transmit a second wavelength range at least partially included in the first range and substantially narrower than the first range.

2. The system as claimed in claim 1, wherein the absorbent material of the lens is selected such that the first wavelength range is centered on a wavelength of the visible spectrum.

3. The system as claimed in claim 2, wherein the optical element is arranged such that the width of the second wavelength range is less than 30 nm.

4. The system as claimed in claim 3, wherein the optical element includes a stack of thin layers each alternately having a high refractive index or a low refractive index.

5. The system as claimed in claim 1, wherein the lens is a plano-convex lens and the optical element is a coating formed on the flat face of the lens.

6. The system as claimed in claim 1, wherein the optical element is a flat plate interposed between the lens and the elementary acquisition module.

7. The system as claimed in claim 1, wherein the optical unit includes a plurality of lenses including the lens forming the first optical filter and at least one further lens made of a transparent material.

8. The system as claimed in claim 1, wherein the reception module includes a demodulation unit connected to the photodetector and arranged to extract a data sequence from an electrical signal converted by the photodetector.

9. The system as claimed in claim 8, further comprising an emission module including a luminous module able to emit a light beam, the spectrum of which has at least one portion in the second wavelength range, and a modulation unit that is able to receive a data sequence and that is arranged to modulate the emitted light beam using the received data sequence.

10. The system as claimed in claim 9, wherein the modulation unit is arranged to generate a pulse-width-modulated control signal, to modulate the control signal using the received data sequence, and to control the emission of the light beam by the luminous module using the modulated control signal.

11. The system as claimed in claim 9, further comprising a computing unit arranged to detect, in a data sequence extracted by the demodulation unit from an electrical signal converted by a photodetector from a light beam received by the reception module, the presence of a data sequence modulating the light beam emitted by the emission module and to determine a time-of-flight separating the emission of the emitted light beam from the reception of the received light beam.

12. The system as claimed in claim 9, wherein the emission module is arranged so that the light beam participates, totally or partially, in the performance of a predetermined statutory photometric function.

13. The luminous system as claimed in claim 1, wherein the reception module is arranged in a front headlight of the automotive vehicle.
